(19) United States
(12) Patent Application Publication
(10) Pub. No.: US 2005/0197821 A1
(43) Pub. Date: Sep. 8, 2005

(54) System and a method for workflow system (engine) based workflow model simulation

(75) Inventors: Byeong-Gyu Choi, Daejeon (KR); Hyeon-Cheol Hwang, Seoul (KR); Seok-Gyu Yoo, Daejeon (KR); Heon-Cheol Jung, Gyeonggi-do (KR)

Correspondence Address: HARNESS, DICKEY & PIERCE, P.L.C., P.O. BOX 828, BLOOMFIELD HILLS, MI, 48303, US

(73) Assignee: Korea Advanced Institute of Science and Technology, Daejon (KR)

(21) Appl. No.: 10/923,771

(22) Filed: Aug. 20, 2004

(30) Foreign Application Priority Data
Mar. 4, 2004 (KR) 2003-14493

(51) Int. Cl. G06F 9/45

(52) U.S. Cl. 703/22

(57) ABSTRACT

The present invention relates to a software system performing direct simulation of workflow process definition model following WFMC (Workflow Management Coalition) within workflow system (engine). The simulation system comprises 1) a global clock for simulation time management, 2) participant simulators receiving work item from workflow system (engine) and starts/terminates the work item, 3) a human participant interface for the direct participation of human in simulation, and 4) a supervisor processing input information required for performing simulation. With attaching the simulation system of the present invention to existing legacy workflow system (engine), and executing predefined process definition model, automatic simulation can be performed, which is called as autonomous simulation. Moreover, the present simulation system also supports constructive simulation mode which directly makes human perform the roles of some participant simulators.

### BACKGROUND OF THE INVENTION

1. Field of the Invention

The present invention relates to a workflow system (engine) based workflow model simulation, in more detail, a system and a method for workflow model simulation using (or interacting with) workflow system (engine (or BPM (business process model)) execution engine) which performs interpretation and execution of workflow model.

Workflow is the computerized facilitation or automation of a business process in whole or part. Based on these features of workflow, workflow system (engine) is defined as the software supporting business process re-engineering, enactment, management, and collaboration through automation of business flow, electronic delivery of information and documents, and coherent data access and control.

Workflow model is an appropriate representation of business environment and business process, in which it represents the construction of organization with the aspects of tasks, actors, role, activity, and repository of data. As such, workflow model can be considered as the operations for creation, change, and simulation of procedures in computer-oriented representation.

2. Description of the Related Art

Recently, studies for the purpose of developing workflow system (engine) for solving a variety of technical subjects happened in the issues of modularization, integration, reuse, distributed processing, standardization, and reliability of applications are in progress. Among those studies, especially those on the software technique for analyzing workflow and verifying data integrity, and the simulation area of analysis and verification for process simulation are active.

The simulation techniques in existing legacy workflow system (engine) are off-line simulation techniques, which convert workflow model to simulation model (Petri-net, SIMAN, etc.) and perform computer simulation using separate simulation system.

Thus, there are following disadvantages in prior arts.
(1) Additional operation for converting to other type of model for simulation is required, and it takes respectable amount of feed back loop time to reflect simulation results to workflow model.
(2) Workflow model capable of simulation has limitations, in which, for example, it's difficult for dynamic routing and dispatching rule to be represented as simulation model, and it cannot be solved with prior arts.
(3) While performing simulation, the reflection of the actual results for previously executed workflow is impossible.
(4) Due to the purpose of education or test for some participants, human in place of participant simulators cannot take part in simulation. (i.e., human-in-the-loop simulation is impossible).

The present invention is devised for solving the issues as described above. Therefore, an objective of the present invention is to make possible for simulation using workflow system (engine) without model conversion for separate simulation on workflow system (engine). By way of this, the evaluation and analysis for workflow model, and the optimization of workflow model through What-if simulation are possible. Another objective of the present invention is to make possible for the test of workflow system (engine) or the training of workflow based information system, and thus, to do this, to enable human in place of some participant simulators directly to take part in the process of simulation.

### SUMMARY OF THE INVENTION

The present invention provides a workflow system (engine) based workflow model simulation system which is structured as simulation is performed at the same time with the execution of workflow system (engine), and characterized in that said workflow model simulation system includes a supervisor processing input information required for performing simulation; a workflow system (engine) executing actual process instances; participant simulators receiving work item from said workflow system (engine) and being in charge of starting/terminating said received work item; and a global clock for simulation time management.

In addition, the present invention provides a workflow system (engine) based workflow model simulation method which is characterized in that said method includes the first step of performing simulation initialization, which includes the activation of supervisor, workflow system (engine), and participant simulators, and the initialization of simulation time in global clock and process definition model for simulation; the second step in which said supervisor repeatedly requests the process initiation corresponding to the simulation input to said workflow system (engine) according to the simulation time in said global clock; the third step in which said workflow system (engine) executes process definition model complying with the request of process initiation from said supervisor and creates work item; the fourth step in which said participant simulators process said created work item; and the fifth step in which said global clock updates simulation time at every request for work item termination.

### BRIEF DESCRIPTION OF THE DRAWINGS

FIG. 1 is a view illustrating a structure of workflow system (engine) based workflow simulation system in accordance with the present invention.

FIG. 2 is a flowchart illustrating the processing procedures of simulation algorithm in the workflow model simulation system in accordance with the present invention.

### DESCRIPTION OF THE NUMERALS ON THE MAIN PARTS OF THE DRAWINGS

10: a supervisory module
20: a workflow system (engine)
30: participant simulators
40: a global clock
50: a human participant interface

### DETAILED DESCRIPTION OF THE EMBODIMENTS

The present invention provides a simulation module architecture and a simulation algorithm performing direct simulation of workflow process definition model following WFMC (Workflow Management Coalition) within workflow system (engine). Moreover, provided that the system attaching said simulation module to legacy workflow system (engine) following WFMC standard executes the predefined process definition model, autonomous simulation can be performed. Here, the term of the workflow definition model being the object of simulation is used for the same meaning as workflow model, and attaching to the system means that workflow system (engine) is interactively operated with legacy workflow system (engine) utilizing API (Application Program Interface) of workflow system (engine) at run-time.

The present invention makes possible for the simulation using workflow system (engine), where said simulation supports constructive simulation that human directly takes part in simulation at run-time like a war game as well as autonomous simulation using existing logical time update technique. The meaning that human can also take part in actual simulation is that human (user) in lieu of the role of participant simulators can collaborate with the interface provided by workflow system (engine) at run-time. That is, human-in-the-loop simulation such as a war game simulation and a flight simulation is possible. At this time, global clock supports two types of time update techniques, one is logical time update and the other is to update processing time of participant simulators as much as the actual participation time scaled in real time factor.

Hereinafter, referring to appended drawings, the structures and operation principles of the present invention are described in detail.

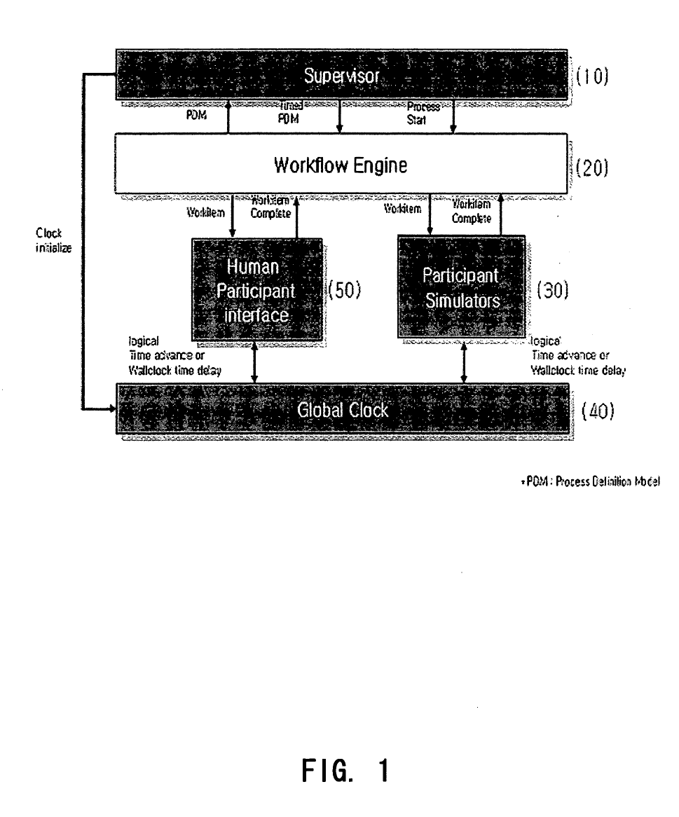

FIG. 1 is a view illustrating a structure of workflow system (engine) based workflow model simulation system in accordance with the present invention, and shows the interface between workflow system (engine) and simulation system.

Referring to the drawing described in FIG. 1, the simulation system of the present invention comprises supervisor (10), workflow system (engine)(20), participant simulators (30), global clock (40), and human participant interface (50), and performs simulation at the same time when workflow system (engine) is at run-time.

Said supervisor (10) provides simulation input (process initiation) while performing simulation.

Said workflow system (engine)(20) actually executes process instances.

Said participant simulators (30) receive work item from workflow system (engine) (20) and plays a role in requesting for start/termination of work item under the consideration of resource limitation.

Said global clock (40) is in charge of managing simulation time, which is updated by means of event-driven or time-stepped method.

Said human participant interface (50) provides an interface for receiving work item from workflow system (engine)(20) and requesting for start/termination of work item with the participation of human in place of participant simulators (30). Simulation algorithm can be executed through the collaboration between workflow system (engine) (20) and simulation system as described above. The present invention makes possible for two simulation modes (i.e., autonomous simulation mode and constructive simulation mode).

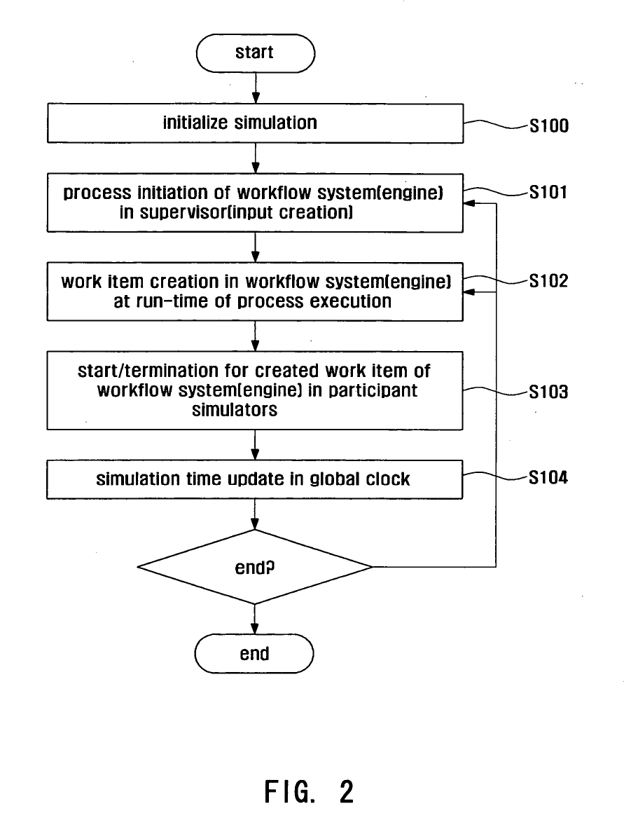

FIG. 2 is a flowchart illustrating the processing procedures of simulation algorithm in workflow model simulation system in accordance with the present invention, in which the algorithm goes through the following 5 steps.

(1) Simulation Initialization (S100):

Initialize the states of each module for performing simulation. That is, activate supervisor (10), workflow system (engine)(20), and participant simulators (30), and initialize simulation time of global clock (40) and process definition model for simulation.

(2) Initiation of Process Instances in Workflow System (Engine)(20)(S101):

Supervisor (10) continuously requests the initiation of process instance corresponding to the input of simulation to workflow system (engine) (20) according to the simulation time in global clock (40).

(3) Process Definition Model Execution and Work Item Creation in Workflow System (Engine)(20)(S102):

Process instances are executed by process initiation request from supervisor (10). At this time, according to process definition, work item for each participant is created and distributed.

(4) Start/Termination for the Created Work Item in Participant Simulators (30)(S103):

For the created work item, responsible participant simulators (30) process the created work item, and then requests the termination to workflow system (engine)(20). Complying with this request, workflow system (engine)(20) terminates work item, and creates next work item following process definition. At this time, in the case of human-participant simulation, human in place of some participant simulators requests the termination of work item through human participant interface.

(5) Simulation Time Update (S104):

At every termination request of work item, global clock (40) updates simulation time. Until all work item created in the corresponding process definition model in the course of simulation is completed or simulation time is terminated, the procedures in the above steps 3-5 are repeated.

By using the workflow simulation module of the present invention and applying said module to currently existing commercial workflow system (or business process model execution engine), the demand of additional cost caused by model conversion and the use of simulation system for separate simulation required for re-engineering already built workflow system (engine) can be eliminated.

Moreover, since the simulation considering current real conditions is possible in the aspect of simulation efficiency, realistic simulation results reflecting the state of workflow system (engine) being in use as they are can be extracted.

Since the additional usage directions of workflow system (engine) can also be shown through simulation, simulation can be shown in advance before workflow system (engine) is built, and thereby, the simulation system can be used for user training.

The present invention can be applied to workflow based business process re-engineering (BPR), the construction of business process management system, efficient advance/load management while operating business process management system, and the provision of evaluation guideline for business process re-engineering (BPR) results.

Since those having ordinary knowledge and skill in the art of the present invention will recognize additional modifications and applications within the scope thereof, the present invention is not limited to the embodiments and drawings described above.

1. A workflow system (engine) based workflow model simulation system which is structured as simulation is performed at the same time with the execution of workflow system (engine), and characterized in that said workflow model simulation system includes a supervisor processing input information required for performing simulation; a workflow system (engine) executing actual process instances; participant simulators receiving work item from said workflow system (engine) and being in charge of starting/terminating said received work item; a human participant interface enabling human directly to take part in training; and a global clock for simulation time management.

2. A workflow system (engine) based workflow model simulation system as claimed in claim 1, characterized in that said participant simulators are simulation systems for actual participant, and process said work item under the consideration of resource limitation, and then requests the termination of the corresponding work item to workflow system (engine).

3. A workflow system (engine) based workflow model simulation system as claimed in claim 1, characterized in that said human participant interface processes work item with the actual participation of human in place of participant simulators, and then requests the termination of said work item to workflow system (engine).

4. A workflow system (engine) based workflow model simulation system as claimed in claim 1, characterized in that said global clock is in charge of updating and managing the simulation time for performing interaction between said workflow system (engine) and participant simulators, and between said workflow system (engine) and human participant interface.

5. A workflow model simulation method in workflow system (engine) based workflow model simulation system in accordance with claim 1, comprising the 5 steps of:
the first step of performing simulation initialization, which includes the activation of supervisor, workflow system (engine), and participant simulators, and the initialization of simulation time in global clock and process definition model for simulation;
the second step in which said supervisor repeatedly requests the process initiation corresponding to the simulation input to said workflow system (engine) according to the simulation time in said global clock;
the third step in which said workflow system (engine) executes process definition model with the request of process initiation from said supervisor and creates work item;
the fourth step in which said participant simulators process said created work item; and
the fifth step in which said global clock updates simulation time at every request for work item termination.

6. A workflow model simulation method as claimed in claim 5, characterized in that said participant simulators in said the fourth step request the termination of the corresponding work item to workflow system (engine) after processing said work item, and said workflow system (engine) terminates the corresponding work item according to the termination request of said work item and creates the next work item according to the process definition.

7. A workflow simulation system capable of supporting two modes at the same time through the simulation method as claimed in claim 6, in which one is autonomous simulation proceeded without participation of human in the course of simulation and the other is constructive simulation proceeded with direct participation of human.

8. A workflow model simulation method as claimed in claim 5, characterized in that said global clock updates the simulation time as event-driven, time-stepped, or hybrid method.
